(19) United States
(12) Patent Application Publication
(10) Pub. No.: US 2007/0174309 A1
(43) Pub. Date: Jul. 26, 2007

(54) MTREEINI: INTERMEDIATE NODES AND INDEXES

(76) Inventor: Primo M. Pettovello, Canton, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/624,510

(22) Filed: Jan. 18, 2007

Related U.S. Application Data
(60) Provisional application No. 60/759,879, filed on Jan. 18, 2006.

(51) Int. Cl. G06F 7/00

(52) U.S. Cl. 707/100

(57) ABSTRACT

An index stored on a digital storage medium is a data structure for indexing one or more data objects. The index data structure includes a plurality of index keys for uniquely identifying potential context items in a data object. Each index key is associated with a potential context item. The index data structure of this embodiment also includes a plurality of intermediate nodes. Each intermediate node is associated with an intermediate node, a root node or subtree root node. Finally, the index structure also includes a set of index attributes associated with each index key.

### CROSS-REFERENCE TO RELATED APPLICATIONS

This application claims the benefit of U.S. Provisional Application Ser. No. 60/759,879 filed Jan. 18, 2006.

### BACKGROUND OF THE INVENTION

1. Field of the Invention

The present invention relates to index data structures useful in indexing data objects such as XML documents.

2. Background Art

With the growth of the Internet, Internet languages based on XML have flourished. XML documents structurally can be treated as connected ordered acyclic graphs that form a spanning tree. Such documents are not multigraphs and do not have self-referencing edges. The set of vertices in XML structures are called nodes. XML is used to directly represent sets of relationships that match these criteria. Typically, such sets are hierarchical tree structures.

XPath is a cyclic graph navigational query language that allows for single or branching path structure access with predicate content filtering used on an XML tree directed by a set of 13 axes navigational primitives. XPath partitions an XML document into four primary axes and a context node, such that the axes are interpreted relative to each context node. The four primary XPath axes are: preceding, following, ancestor and descendent. The remaining secondary axes can be algebraically derived from these four primary axes. Relative to the context node, ‘h’, the primary axes sets are graphically depicted in FIG. 1. In FIG. 1, the primary axes are encapsulated in dotted lines and span the entire graph.

XPath queries are processed from left to right location steps by location steps with “/” or ‘//’ as separators. Upon execution, XPath queries return one or more sets of nodes, called a sequence, for each location step using as input the set of nodes returned in the previous location step query in document order with duplicates eliminated. Location steps are composed of an axis, a node test and zero or more predicates: axis::node-test[predicate]*. Node tests match the vertex label, called a qualified name (or qname) in XML. For example, an XPath query may appear as such: //descendent-or-self::g[h/j]

Recently, there has been a large focus in the literature around the many problems and potential solutions for implementing XML within RDBMS systems. Many solutions have been proposed that transform the XML space to the Relational space, yet several open query problems remain with the mapping including the XML-to-SQL translation problem and query containment optimization. Alternative solutions are being sought that can avoid expensive SQL join operations, including efforts by commercial database vendor research departments. There has been much work around optimizing ancestor-descendent and parent-child linkages, but less focus has been placed on solving the antagonistic following and preceding XPath axes.

The primary prior art indexing method for relational technology is a B−Tree, designed to be optimal for height balance and O(lg(n)) singleton row level access. Hierarchical XML data structures and in general generic hierarchical mapping to relational is done using various techniques with recursive edge mapping providing the most universal solution, but also the lowest level of performance. Edge mapping requires chopping up the XML tree into small discrete pieces where the edges are indexed by a B−Tree index. The reason performance is so poor for XPath is that for each query each of the discrete pieces needs to be identified and retrieved and then reassembled into the proper subtrees to satisfy the query, a lengthy process.

### SUMMARY OF THE INVENTION

The present invention solves one or more problems of the prior art by providing in one embodiment, an extended and improved MTreeINI index. The index of this embodiment is a data structure for indexing one or more data objects. The index data structure includes a plurality of index keys for uniquely identifying potential context items in a data object. Each index key is associated with a potential context item. The index data structure of this embodiment also includes a plurality of intermediate nodes. Each intermediate node is associated with an intermediate node, a root node or subtree root node. Finally, the index structure also includes a set of index attributes associated with each index key. Each set of attributes includes a reference selected from the group consisting of: a first reference for locating a preceding root node, a subtree root node or an intermediate node, the first reference being singly linked or multiply linked; a second reference for locating a following root node, a subtree root node or an intermediate node, the second reference being singly linked or multiply linked; and combinations thereof. Advantageously, the index data structure is stored on a digital storage medium. Methodology for building, modifying, and querying the index data structures of this embodiment are also provided.

### BRIEF DESCRIPTION OF THE DRAWINGS

FIG. 1 shows intermediate nodes within MTree subtrees.

FIG. 2 shows intermediate nodes that are B−Tree intermediate nodes within MTree subtrees.

FIG. 3 shows intermediate nodes that are R−Tree intermediate nodes within MTree subtrees.

FIG. 4 shows intermediate nodes that are generic data structure intermediate nodes within MTree subtrees.

FIG. 5 shows cache index trees within MTree.

FIG. 6 shows cache index tree B−Tree root nodes within MTree.

FIG. 7 shows cache index tree R−Tree root nodes within MTree.

FIG. 8 shows cache index tree generic data structure root nodes within MTree.

FIG. 9 shows cache index tree root nodes combined with generic data structure cache index within MTree.

### DETAILED DESCRIPTION OF THE PREFERRED EMBODIMENT(S)

The term “generic index data structure” as used herein refers to any defined index data structure such as, but not limited to: MTree, B−Tree, B+Tree, B*Tree, 2-3 Tree, GIST Tree, R−Tree, Suffix Tree, Bitmap, Hash Map, Distributed Hash Tables, Quadtree, and other variants, and portions thereof, and combinations thereof.

The term “generic data structure” as used herein refers to any defined data structure include generic index data structures and other data structures such as routing tables, WSDL files, documents, XML documents, databases, database objects, multimedia objects and other data objects.

The term “DFS” as used herein refers to the well known computer science tree traversal search method known as depth first search or the ordered sequence of nodes produced that has the same ordered result that this method produces.

The term “BFS” as used herein refers to the well known computer science tree traversal search method known as breath first search or the ordered sequence of nodes produced that has the same ordered result that this method produces.

The term “doubly linked” as used herein refers to the well known computer science definition for a pair of nodes each having references that point to each other.

The term “secondary index” as used herein refers to an index or partial index that has an order that is different from the primary ordering of the nodes produced in DFS sequence.

The term “sparse sequential numbering” as used herein refers to nodes that are numbered using integers spaced with fixed or variable intervals greater than one.

The term “complete descendent subtree” as used herein is the set of all nodes that are descendents of some subtree root node.

The term “partial result node sequence” as used herein refers to an ordered set of subtree root nodes that may include duplicates, such that when the duplicates are eliminated and when the complete descendent subtree is traversed using DFS, the resulting output is a node sequence as expected to be produced by XPath 2.0.

The term “intermediate node” means a potential root node or subtree root node of a potential generic index data structures or portions thereof.

The term “intermediate node set” means a plurality of intermediate nodes.

The term “context item” means the item currently being processed. An item is either an atomic value, a node or a generic data structure. Items are attached to nodes directly or via references.

The present invention represents an improvement over the MTree data index set forth in U.S. patent application Ser. No. 11/233,869 filed on Sep. 22, 2005 and represents an improvement to MTreeP2P, the Peer-to-Peer Semantic Index set forth in U.S. patent application Ser. No. 11/559,887 filed on Nov. 14, 2006, the entire disclosures of both these applications are hereby incorporated by reference. The present invention is referred to herein as “MTreeINI”. Embodiments of the present invention provide improvements to these references by allowing not only single links, but double links between pairs of nodes. Embodiments of the present invention provide further improvements by adding intermediate nodes between the parent node and the children nodes to improve query, insert, delete and update efficiency. Additional advantages are provided by variations of the present invention which include additional cache data structures to improve query performance. Intermediate nodes are introduced into MTree and MTreeP2P to enable additional optimizations within each child sequence. The intermediate nodes are partial generic index search tree structures or combinations thereof depending upon the types of local optimizations selected.

In an embodiment of the present invention, an extended and improved MTreeINI index is provided. The index of this embodiment is a data structure for indexing one or more data objects. The index data structure includes a plurality of index keys for uniquely identifying potential context items in a data object. Each index key is associated with a potential context item. The index data structure of this embodiment also includes a plurality of intermediate nodes. Each intermediate node is associated with an intermediate node, a root node or subtree root node. Finally, the index structure also includes a set of index attributes associated with each index key. Each set of attributes includes a reference selected from the group consisting of: a first reference for locating a preceding root node, a subtree root node or an intermediate node, the first reference being singly linked or multiply linked; a second reference for locating a following root node, a subtree root node or an intermediate node, the second reference being singly linked or multiply linked; and combinations thereof. Advantageously, the index data structure is stored on a digital storage medium. Useful storage media may be volatile or non-volatile. Examples includeRAM, hard drives, magnetic tape drives, CD-ROM, DVD, optical drives, and the like.

The MTreeINI index data structure further includes a set of index attributes selected from the group consisting of: a plurality of atomic values; a plurality of node references related to one or more additional generic data structures or generic index data structure; and combinations thereof.

In a variation of the MTreeINI index data structure, the set of index attributes further comprises a reference selected from the group consisting of: a third reference for locating a node in the ancestor axis, the third reference being singly linked or multiply linked; a fourth reference for locating a node the descendent axis, the fourth reference being singly linked or multiply linked; and a fifth reference to an intermediate node set for locating a node in the descendent axis, the fifth reference being singly linked or multiply linked; and combinations thereof. In a variation of the MTreeINI index data structure, one or more of the first reference, second reference, third reference, fourth reference, and fifth reference are doubly linked.

In another variation of the MTreeINI index data structure, the first reference for locating a node in the ancestor axis is a reference to the parent node of the context item, or a reference to an intermediate node with the first reference being singly linked or multiply linked. Similarly, the second reference for locating a preceding subtree root node is a reference to the closest preceding subtree root node, or a reference to an intermediate node with the second reference being singly linked or multiply linked. Similarly, the third reference for locating a following subtree root node is a reference to the closest following subtree root node, or a reference to an intermediate node with the third reference being singly linked or multiply linked. Similarly, the fourth reference for locating a node in the descendant axis is a reference to a child node of the context item or is a reference to an intermediate node set that is a reference to a child node of the context item, the forth reference being singly linked or multiply linked.

In still another variation of the MTreeINI index data structure, the fourth reference is to a descendent subtree root node selected from the group consisting of a first descendant child node, a last descendant child node and an intermediate node set.

In some variations of the present embodiment, the MTreeINI index data structure wherein the data object is a hierarchical data object.

In still other variations of the MTreeINI index data structure, the generic index data structure is an object or part of an object selected from the group consisting of an MTree index, B−Tree index, B+Tree index, 2-3 Tree index, GiST index, R−Tree index, Suffix tree index, Bitmap index, Hashmap index, Distributed Hash Table index, Quadtree, and other variants, and portions thereof, and combinations thereof.

In yet another variation of the MTreeINI index data structure, a node contains references to a data object. Examples of such data objects include, but are not limited to, an XML document, a collection of XML documents, a collection of distributed computers, a distributed service, a collection of distributed services, hierarchical file systems, data structures, data files, audio streams, video streams, XML file system, relational database tables, mutlidimensional tables, computer graphics geometry space, polygon space, and combinations thereof.

In yet another variation of the present embodiment, the set of attributes further comprises one or more additional references to data associated with one or more context items or one or more intermediate nodes. In a further refinement of the present variation, the set of attributes further comprises at least one reference to a node having data related to the context item or an intermediate node wherein the related data is optionally selected from data objects, node attributes, qnames, and combinations thereof.

In still another variation of the present embodiment, the nodes and intermediate nodes are numbered using integers spaced with intervals greater than one, and the interval distance between consecutive node references is fixed or variable.

In still another variation of the present invention, the nodes and intermediate nodes are stored on a digital storage medium in breadth first search cluster order. In a further refinement, the nodes are stored on a digital storage medium in a combination of depth first search cluster order and breadth first search cluster order.

In still another variation of the present invention, the nodes are indexed by a composite of four generic index data structures: one generic index structure for the following axis; and one generic index for the preceding axis; and one generic index for the ancestor axis; and one generic index for the descendent axis.

In still another variation of the present invention, the following references for an attribute name node are singly or multiply linked to attribute nodes having the same name, and the preceding references for an attribute node are singly or multiply linked to attributes having the same name.

In another embodiment of the present invention, a method of creating the MTreeINI index data structure is provided. The details of the MTreeINI index data structure are set forth above. The steps of the method of this embodiment are executed by a computer processor with the MTreeINI index data structure being present in volatile memory, non-volatile memory or a combination of both volatile and non-volatile memory. In particular, the method of this embodiment is executed by microprocessor-based systems. The method of this embodiment includes a step of traversing the one or more data objects or intermediate nodes to identify a plurality of nodes, and a step of associating with each node an index key and a set of index attributes. Each set of index attributes comprises: a first reference for locating a preceding subtree root node; a second reference for locating a following subtree root node; an optional third reference for locating a node in the ancestor axis; an optional fourth reference for locating a node in the descendent axis; and an optional fifth reference for locating a node in the descendent axis using a set of intermediate nodes; and wherein the index key uniquely identifies potential context items in the one or more data objects. The method of this embodiment also includes a step in which the index key, intermediate nodes and the associated set of index attributes are stored on a digital storage medium.

In another embodiment of the present invention, a method of accessing the MTreeINI index data structure is provided. The steps of the method of this embodiment are executed by a computer processor with the MTreeINI index data structure being present in volatile memory, non-volatile memory or a combination of both volatile and non-volatile memory. In particular, the method of this embodiment is executed by microprocessor-based systems. The method of this embodiment includes a step of traversing the one or more data objects. This step may include either a depth first search or a breadth first search. In various refinements, the depth first search is preorder, in order, or post order. In a variation of this embodiment, the set of index attributes further comprises one or more additional references to data associated with one or more context items and intermediate nodes. In a further refinement, the set of attributes further comprises at least one reference to a node having data related to the context item. Such related data is optionally selected from node attributes, qnames, and combinations thereof.

In another embodiment of the present invention, methods of insertion and deletion from the MTreeINI index data structure is provided. The steps of the method of this embodiment are executed by a computer processor with the MTreeINI index data structure being present in volatile memory, non-volatile memory or a combination of both volatile and non-volatile memory. In particular, the method of this embodiment is executed by microprocessor-based systems. A method of insertion includes a step of adding an index key, a set of index attributes and a set of intermediate nodes to the index data structure associated with a new node that is added to the data object. A method of deletion includes a step of removing an index key, a set of index attributes and a set of intermediate nodes from the index data structure associated with a node that is removed from the data object.

In another embodiment of the present invention, a method of querying the MTreeINI index data structure is provided. The details of the MTreeINI index data structure are set forth above. The steps of the method of this embodiment are executed by a computer processor with the MTreeINI index data structure being present in volatile memory, non-volatile memory or a combination of both volatile and non-volatile memory. In particular, the method of this embodiment is executed by microprocessor-based systems. The method of this embodiment comprises parsing a query into elementary steps, executing the elementary steps on the index data structure, and return results of the query wherein the query optionally comprises one more location steps.

The keys for intermediate nodes optionally are the prefix number, or complex composites that are comprised of combinations of relevant values such as the prefix number and ordinal child offset count, or more distinctly multiple intermediate node structures having different orderings such as a separate combination that includes qnames in lexicographic order in a B−Tree or suffix tree, attribute names in lexicographic order in a B−Tree or suffix tree, or prefix order numbers combined with offset child ordinal numbers.

Intermediate nodes are on qname, on attribute names, on qname values and on attribute values. Thus, the intermediate nodes can index the attribute values in the first attribute or index the attribute values of a named attribute. Intermediate nodes using the ordered key, a.k.a. clustering key, a.k.a. primary key, typically the node prefix number do not need leaves as the siblings are the leaves. Secondary intermediary indexes are added that have a different sort order than the primary key such as on attribute names or values, qnames or qname values, text data.

The intermediate nodes or intermediate node indexes are created in streaming mode using a separate stack for each index. When the ordering index is the same as the child nodes then the child nodes are reused and thus only the intermediate nodes need to be maintained.

Since the nodes are in document order, the sibling node numbers are in ascending order, thus, by storing the ordinal node numbers in the intermediate structures quick child navigation is achievable when the node offset is requested in a predicate. The intermediate structure is numbered by sparse sequential numbering where the numbers are offset numbers of the children relative to a parent subtree root node.

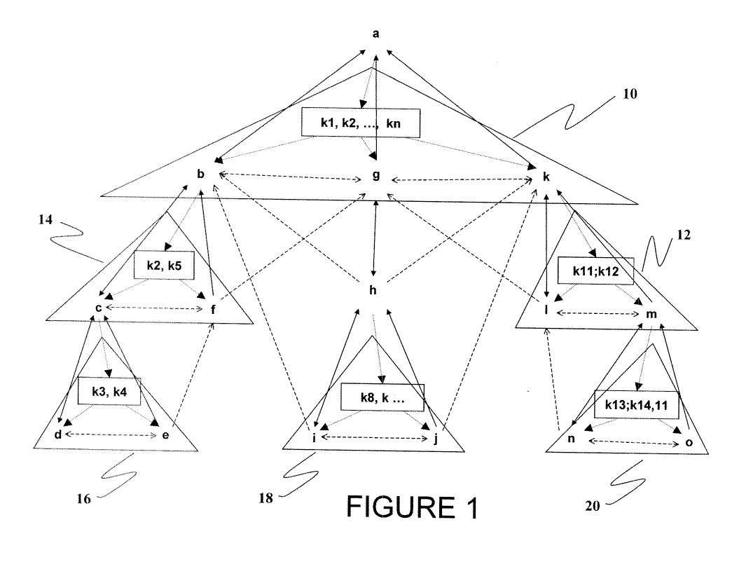

In FIG. 1, each triangle outline demarks a separate generic data structure embedded and integrated within the MTree structure index, each contains various types of intermediate nodes. Each triangle is polymorphic and optimized for the instance at that level. The triangle is polymorphic in that within the same index each triangle instantiates the same or a different generic data structure. For example, Box 10 may be instantiated as an AVL tree, Box 12 and Box 14 may be instantiated as B−Tree and Box 16, Box 18 and Box 20 may be instantiated using R−Tree, all active simultaneously.

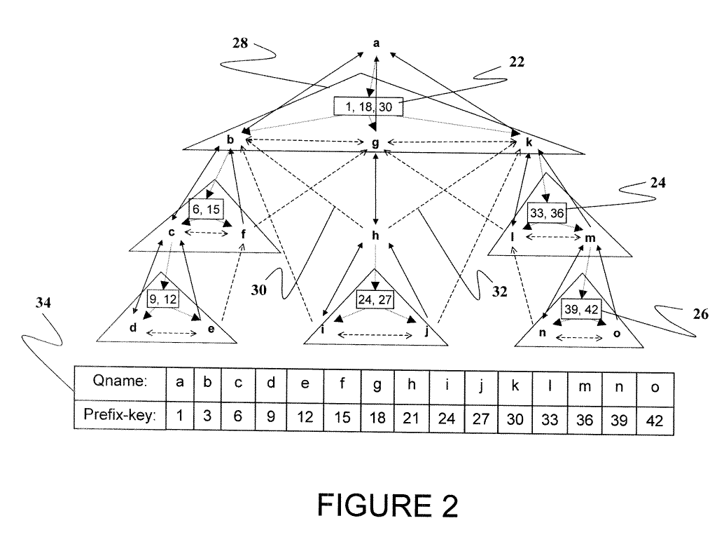

FIG. 2 shows a special case where each of the subtree intermediate nodes are the inner part of B−Trees residing under each subtree root node within an MTree structure, an MB−Tree. The intermediate nodes are B−Tree node structures key by prefix. The intermediate nodes, examples shown in Box 22, Box 24 and Box 26, contain bifurcated node numbers and reside between the parent node and the sibling nodes and are used to supplement query optimization. The intermediate nodes have the same structure as B−Tree intermediate nodes. The intermediate structure numbers leaf nodes by sequential offset numbers of the children relative to a parent node when the child structure is known and repeating, and the intermediate structure numbers leaf nodes using the MTN when repeating structure is not present or known.

Thus, each triangle outline represents a separate logical B−Tree structure embedded within the MTree structure index and integrated at the leaf level with the child axis. In FIG. 2, observe Box 30 shows the preceding reference from node h referencing another B−Tree Box 28 via node b. Observe Box 32 shows the following reference from node h referencing node k in another B−Tree. Box 34 shows the mapping between qnames and prefix key values. In this example, the table is global because the overall tree size is small, but for large trees a secondary mapping table is created for each triangle that maps the integer ordinal offset of the qname to the ordering within each subtree.

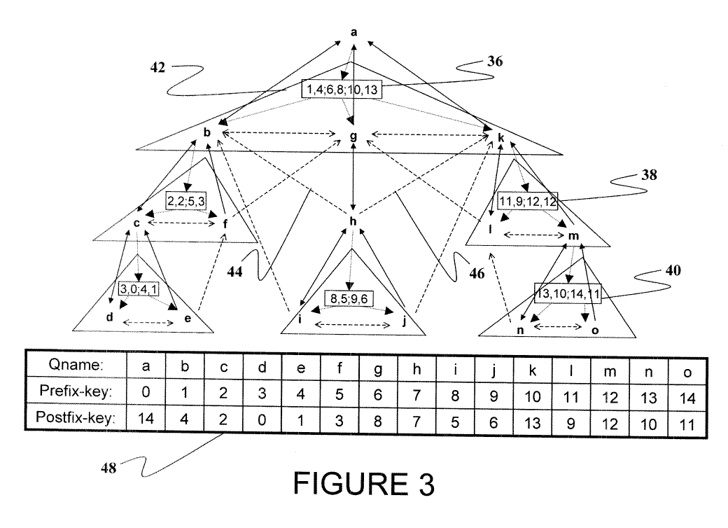

In FIG. 3, we now show a two-dimensional structure embedded within MTree and indexed by MTree. FIG. 3 shows MR+Tree Version Schematic Model. The intermediate nodes, examples shown in Box 36, Box 38 and Box 40 contain two-dimensional references, in this example, keyed by prefix and postfix numbers at each node. The two-dimensional references can be implemented using two separate B−Trees or by using one multidimensional RTree. Box 42 shows how the global mapping table appears. Similarly, for large trees, a secondary mapping table is created for each triangle that maps the integer ordinal offset of the qname to the ordering within each subtree.

Each triangle, for example Box 42, outline demarks a separate RTree structure embedded within the MTree structure index and leaf nodes are integrated with the child axis. Box 44 shows a preceding reference from node h linking to RTree Box 42, and Box 46 shows a following reference linking node h to the RTree referenced by Box 42. Box 48 shows the mapping between qnames and prefix and postfix key values. In this example, the table is global because the overall tree size is small, but for large trees a secondary mapping table is created for each triangle that maps the integer ordinal offset of the qname to the ordering within each subtree.

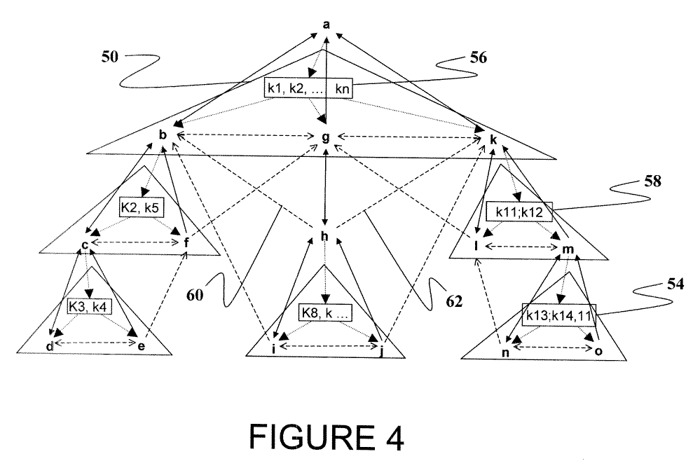

In FIG. 4, the intermediate nodes are SAM, spatial access method, nodes. The structure is called a [SAM]+Tree. Each triangle outline demarks a separate SAM structure embedded and integrated within the MTree structure index. Spatial keys are stored at each node. Intermediate nodes are SAM intermediate nodes. Thus, the index is k-d, k-dimensional. Box 54, Box 56 and Box 58 show intermediate spatial key references. Box 60 shows a preceding reference from one spatial index tree node h to another spatial index tree Box 50. Box 62 shows a following reference from one spatial reference tree node h to another spatial index tree Box 50.

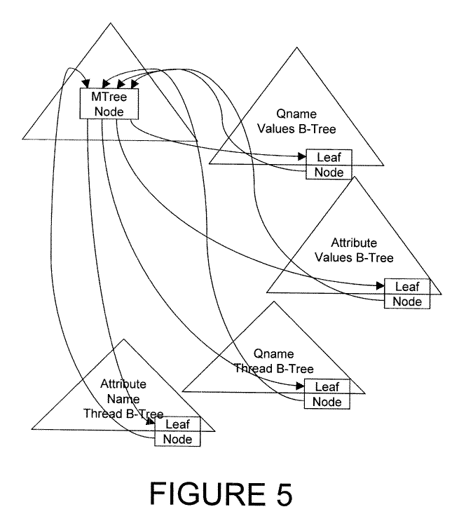

In FIG. 5, we see a cache structure for MTree, MCache, node references that is comprised of two AVL or B−Tree structures for qnames and attribute names and two AVL or B−Tree structures for attribute values and qname values. Nodes are doubly linked between the AVL or B−Tree cache into the thread structure leaf nodes. This method allows for efficient processing for locating nodes to support rapid index modifications and for advanced query optimizations.

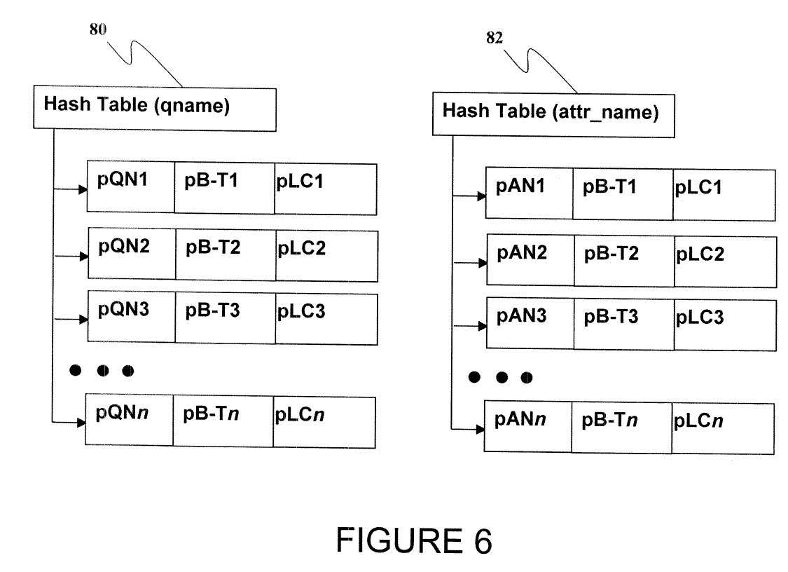

In FIG. 6 we see an MCache structure using a Hash map for qnames and attribute names that contain references to roots of B−Trees containing MTree node references. pBTn is the B−Tree root reference for a specific qname or attribute name. The leaf nodes of the B−Tree are the actual MTree nodes that are threaded into the actual MTree. Thus, the cache is directly integrated into the MTree index. Box 80 shows the qname, the qualified name, cache. Box 82 shows the attr_name, the attribute name, cache. The value pQNn is the reference to the qualified name, qname, string value. The value pANn is the reference to the attribute name string value. The value pLCn is the reference to the level cache.

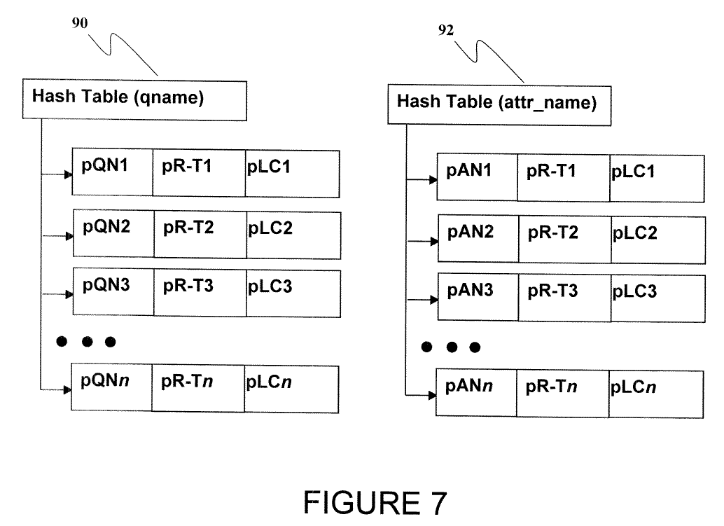

In FIG. 7 we see an MCache structure using a Hash map for qnames and attribute names that contain references to roots of RTrees containing MTree node references. pR+Tn is the RTree root reference for a specific qname or attribute name. The leaf nodes of the RTree are the actual MTree nodes that are threaded into the actual MTree. Thus, the cache is directly integrated into the MTree index. Box 90 shows the qname, the qualified name, cache. Box 92 shows the attr_name, the attribute name, cache. The value pQNn is the reference to the qualified name, qname, string value. The value pANn is the reference to the attribute name string value. The value pLCn is the reference to the level cache.

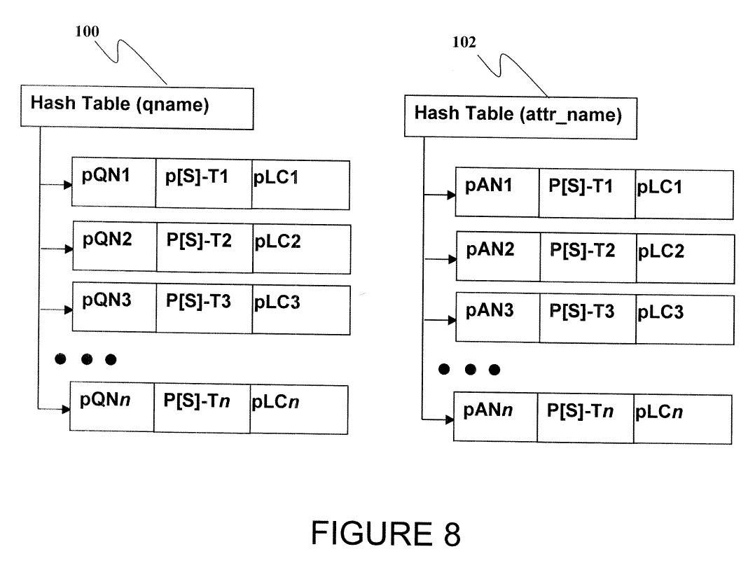

In FIG. 8 we see an MCache structure using a Hash map for qnames and attribute names that contain references to roots of SAMTrees, spatial access method trees, containing MTree node references. P[S]+Tn is the RTree root reference for a specific qname or attribute name. The leaf nodes of the RTree are the actual MTree nodes that are threaded into the actual MTree. Thus, the cache is directly integrated into the MTree index. Box 100 shows the qname, the qualified name, cache. Box 102 shows the attr_name, the attribute name, cache. The value pQNn is the reference to the qualified name, qname, string value. The value pANn is the reference to the attribute name string value. The value pLCn is the reference to the level count, which maintains the count of each qname at each level in the index and is used to assist optimization of some queries.

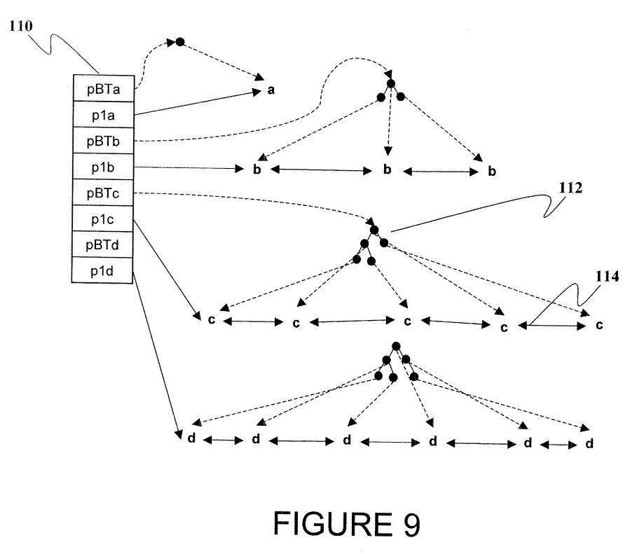

In FIG. 9 we see an alternate view of the MCache structure for qualified name, qname. Box 110 shows the base table that contains references to the BTree root nodes for qnames={a, b, c, d} one BTree for each unique qname. In addition, one additional reference p1[qname] that points to the first node in document order for each unique qname. Box 112 shows the BTree that indexes the nodes by node references for keys. Box 114 shows the qname thread. The attribute name cache threads “attributes” having the same label in document order. The qname cache threads “qnames” having the same label in document order.

MCache returns a sequence of nodes for a given qname in document order. The cache index is used to return the set of nodes for the first location step for wild card descendent “//” axis type queries as an alternative to performing an entire index scan to determine closure. The cache is used for qname existence checking and improved wild card search performance, since the cache can return the node sequence in O(1), which is equivalent to thread implementation, but is more space contiguous. A BTree is selected to manage the qname node set to allow for better cache insert and delete performance for updateable XML documents. When documents are read only then some structures are omitted and a more space compressed index is used.

The organization of the cache is used to support several query optimization strategies. For example, when traversing the tree downward in a wildcard, “//”, scan the cache can return the number of nodes for each qname at each level. Once the number of nodes found at a given level exceeds the number of nodes possible at that level that level will no longer be scanned. Additionally, as the tree is traversed downward the cache level count is used to determine if nodes exist at lower levels otherwise the index scan ends.

The first set of tests with “//” queries used a naïve approach that started with MTree root and examined each node in the entire index tree for a match. For the first location step this resulted in an O(N) scan of the index tree. The first location step wild card presents the biggest set closure challenge, since candidate nodes can be anywhere in the tree. After introducing the cache, results for the first location step query can be made available in O(1).

Based on the experiments with XMark test data, the biggest performance gain compared to doing a full index scan is achieved from using the cache or using qname threads in the first location step wild card query, regardless of the cache usage method used, top-down or bottom-up. The bottom-up tree traversal method uses the cache to obtain all the candidate nodes requested in the last location step of a query, and then traverses the ancestor axis to verify the path to the root matches the location step sequence in the query path.

In another embodiment, a unique node numbering method can be used, herein called “MTN”. The numbering method that provides the most benefit is the DFS traversal prefix number, since it has multiple uses such as uniqueness and ordering. The traditional well known method is to use sequential integer numbers, incremented by one, for numbering. Using this numbering scheme will inhibit insert processing, since the tree will renumber large numbers of nodes to fit in new nodes. To efficiently enable insert processing a different method is needed. MTree uses sparse sequential integer numbering. The advantage of sparse sequential numbering is that a fixed space representation is used that allows for inserts.

Node numbering is not directly needed for queries or inserts, but node numbering is used for efficient maintenance of the qname and attribute-name threads as a result of inserts. Upon insert, if the interval between two nodes becomes too small, nodes adjacent to the interval nodes at the location of insert are renumbered to shift the space available from the larger interval outside of the insert window into the smaller interval. For example, suppose given three nodes numbers {4, 5, 15, 30} with a need to insert two nodes between nodes 4 and 5, node 5 is renumbered to now become node 10. The value 10 is computed ((15−5)/2)+node=5+5=10, this gives a new sequence {4, 10, 15, 30} and after insert the final sequence {4, 6, 8, 10, 15, 30}. If the new interval is too small after the computation the next following (or preceding) node is examined, in this example node 30, this process continues recursively, alternating between following and preceding until a new interval can be created that is large enough to handle the inserted subtree node set plus the existing nodes that are renumbered.

Recursion algorithm example:
Suppose the graph depicted in FIG. 3 and the query:

### Query A: //*/following::*/following::*/following::*

We start with the complete node sequence for the entire tree “//*”={a, b, c, d, e, f, g, h, i, j, k, l, m, n, o}. The next location step query //*/following::* retrieves the following node of each node in the input list, using the following axis yields the subtree root forest {e, f, g, h, i, j, k, l, m, n, o}. For the intermediate step: nodes {a, k, m, o} have no following, and thus, produce no nodes; node b produces g, node c produces f, node d produces e, node e produce f, node f produces g, node g produces k, node h produces k, node i produces j, node j produces k, node l produces m, and node n produces o resulting in subtree root node sequence {e, f, g, g, h, j, k, k, k, m, o}. It should be noted that duplicates exist in the output node set, but the node set is in increasing order. Thus, duplicates are eliminated by traversing the list from left to right in a single pass. Removing duplicates yields the intermediate, partial result node sequence {e, f, g, h, j, k, m, o}. To produce the output node sequence each node is examined for children that may exist using DFS that are not in the list, which are included in the expected result set, all nodes in the intermediate partial results step are treated as subtree root nodes that need to be traversed. After traversing all the complete descendent subtrees and outputting the unique children the result is {e, f, g, h, i, j, k, l, m, n, o}. If the next location query step can accept as input an intermediate partial result sequence then an additional optimization is used.

When the node number fragmentation becomes too great, that is, the interval numbers between many nodes becomes very small, the index numbering prefix scheme can simply be reset by doing a DFS traversal of the nodes to reassign the prefix numbers with the current integer counter.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An index data structure for one or more data objects, the index data structure comprising:
a) a plurality of index keys for uniquely identifying potential context items in a data object, each index key being associated with a potential context item; and
b) a plurality of intermediate nodes, each intermediate node being associated with an intermediate node, a root node or subtree root node; and
c) a set of index attributes associated with each index key, each set of attributes comprising a reference selected from the group consisting of:
a first reference for locating a preceding root node, a subtree root node or an intermediate node, the first reference being singly linked or multiply linked;
a second reference for locating a following root node, a subtree root node or an intermediate node, the second reference being singly linked or multiply linked; and
combinations thereof;
wherein the index data structure is stored on a digital storage medium.

2. The index data structure of claim 1 wherein the set of index attributes further comprises attribute selected from the group consisting of:
a plurality of atomic values;
a plurality of node references related to one or more additional generic data structures or generic index data structure; and combinations thereof.

3. The index data structure of claim 1 wherein the set of index attributes further comprises a reference selected from the group consisting of:
a third reference for locating a node in the ancestor axis, the third reference being singly linked or multiply linked;
a fourth reference for locating a node in the descendent axis, the fourth reference being singly linked or multiply linked; and
a fifth reference to an intermediate node set for locating a node in the descendent axis, the fourth reference being singly linked or multiply linked; and combinations thereof.

4. The index data structure of claim 3 wherein one or more of the first reference, second reference, third reference, fourth reference, and fifth reference are doubly linked.

5. The index data structure of claim 4 wherein:
the first reference for locating a node in the ancestor axis is a reference to the parent node of the context item, or a reference to an intermediate node, the first reference being singly linked or multiply linked;
the second reference for locating a preceding subtree root node is a reference to a closest preceding subtree root node, or a reference to an intermediate node, the second reference being singly linked or multiply linked;
the third reference for locating a following subtree root node is a reference to a closest following subtree root node, or a reference to an intermediate node, the third reference being singly linked or multiply linked; and
the fourth reference for locating a node in the descendant axis is a reference to a child node of the context item or is a reference to a an intermediate node set that is a reference to a child node of the context item, the forth reference being singly linked or multiply linked.

6. The index data structure of claim 5 wherein the fourth reference is to a descendent subtree root node selected from the group consisting of a first descendant child node, a last descendant child node and an intermediate node set.

7. The index data structure of claim 1 wherein the data object is a hierarchical data object.

8. The index data structure of claim 1 wherein the generic index data structure is an object or part of an object selected from the group consisting of an MTree index, B−Tree index, B+Tree index, 2-3 Tree index, GiST index, R−Tree index, Suffix tree index, Bitmap index, Hashmap index, Distributed Hash Table index, Quadtree, and other variants, and portions thereof, and combinations thereof.

9. The index data structure of claim 1 wherein a node contains references to a data object, an object selected from the group consisting of an XML document, a collection of XML documents, a collection of distributed computers, a distributed service, a collection of distributed services, hierarchical file systems, data structures, data files, audio streams, video streams, XML file system, relational database tables, mutlidimensional tables, computer graphics geometry space, polygon space, and combinations thereof.

10. The index data structure of claim 1 wherein the set of attributes further comprises one or more additional references to data associated with one or more context items or one or more intermediate nodes.

11. The index data structure of claim 10 wherein the set of attributes further comprises at least one reference to a node having data related to the context item or an intermediate node wherein the related data is optionally selected from data objects, node attributes, qnames, and combinations thereof.

12. The index data structure of claim 1 wherein the nodes and intermediate nodes are numbered using integers spaced with intervals greater than one, and the interval distance between consecutive node references is fixed or variable.

13. The index data structure of claim 1 wherein the nodes and intermediate nodes are stored on a digital storage medium in breadth first search cluster order, and the nodes are stored on a digital storage medium in a combination of depth first search cluster order and breadth first search cluster order.

14. The index data structure of claim 1 wherein the nodes are indexed by a composite of four generic index data structures: one generic index structure for the following axis; and one generic index for the preceding axis; and one generic index for the ancestor axis; and one generic index for the descendent axis.

15. The index data structure of claim 1 wherein the following references for an attribute name node are singly or multiply linked to attribute nodes having the same name, and the preceding references for an attribute node are singly or multiply linked to attributes having the same name.

16. A method of creating an index data structure for one or more data objects having one or more nodes, the method comprising:
a) traversing the one or more data objects or intermediate nodes to identify a plurality of nodes;
b) associating with each node an index key and a set of index attributes, wherein each set of index attributes comprises:
a first reference for locating a preceding subtree root node;
a second reference for locating a following subtree root node;
an optional third reference for locating a node in the ancestor axis;
an optional fourth reference for locating a node in the descendent axis; and
an optional fifth reference for locating a node in the descendent axis using a set of intermediate nodes; and
wherein the index key uniquely identifies potential context items in the one or more data objects; and
c) storing the index key, intermediate nodes and the associated set of index attributes on a digital storage medium.

17. The method of claim 16 wherein the step of traversing the one or more data objects comprises a depth first search or a breadth first search.

18. The method of claim 16 wherein the step of traversing the one or more data objects comprise a depth first search that is preorder, in order, or post order.

19. The method of claim 16 wherein the set of index attributes further comprises one or more additional references to data associated with one or more context items and intermediate nodes.

21. The method of claim 19 wherein the set of attributes further comprises at least one reference to a node having data related to the context item.

22. The method of claim 19 wherein the related data is selected from node attributes, qnames, and combinations thereof.

23. The method of claim 16 further comprising adding an index key, a set of index attributes and a set of intermediate nodes to the index data structure associated with a new node that is added to the data object.

24. The method of claim 16 further comprising removing an index key, a set of index attributes and a set of intermediate nodes from the index data structure associated with a node that is removed from the data object.

25. A method of querying an index data structure, the index structure comprising:
a) a plurality of index keys for uniquely identifying potential context items in a data object, each index key being associated with a potential context item;
b) a set of index attributes associated with each index key, each set of attributes comprising:
a first reference for locating a node in the ancestor axis;
a second reference for locating a preceding subtree root node;
an optional third reference for locating a following subtree root node; and
an optional fourth reference for locating a node in the descendent axis; and
an optional fifth reference for locating a node in the descendent axis using a set of intermediate nodes; and
wherein the index data structure is stored on a digital storage medium,
the method comprising:
a) parsing a query into elementary steps;
b) executing the elementary steps on the index data structure; and
c) returning results of the query wherein the query optionally comprises one more location steps.
